(19) United States
(12) Patent Application Publication
(10) Pub. No.: US 2014/0046866 A1
(43) Pub. Date: Feb. 13, 2014

(54) Systems and Methods for the Distribution of Donations to Charities

(71) Applicants: Julian Otto Worth, Lauenen bei Gstaad (CH); David Andrew Hallett, Bussy-Chardonney (CH)

(72) Inventors: Julian Otto Worth, Lauenen bei Gstaad (CH); David Andrew Hallett, Bussy-Chardonney (CH)

(73) Assignee: XPEREDON Group S.A., Luxembourg (LU)

(21) Appl. No.: 13/985,626

(22) PCT Filed: Feb. 18, 2011
(86) PCT No.: PCT/IB11/50684

§ 371 Date: Oct. 23, 2013

(51) Int. Cl. G06Q 30/02

(52) U.S. Cl. CPC G06Q 30/0279
USPC 705/329

(57) ABSTRACT

A computerized system for managing the distribution of charitable donations among a plurality of beneficiaries selectable by the donors or by authorized third parties, wherein the system comprises data input means (an Internet site) enabling donors or authorized third parties who access the system via the data input means to each select one or more beneficiaries or to alter their selection of beneficiaries to create a personal donation profile or PDP. The system is so arranged that when a given donor or authorized third party accesses the data input means to establish or modify a selected PDP, he can adopt at least one previously-established PDP such that successive donors or authorized third parties can likewise establish new or modified PDPs which adopt previously-established PDPs.

### FIELD OF THE INVENTION

This invention relates to computerized systems and methods for the distribution of donations to a plurality of beneficiaries, for example charities.

### BACKGROUND ART

There have been various proposals for facilitating the collection and distribution of charitable donations. One consists in a fundraiser opening a website page to invite donations from friends and acquaintances, which are collected and distributed to a chosen charity.

WO 2009/036362 discloses a system enabling cardholders to make contributions like charitable donations as a function of their credit card expenditure, which system stores beneficiary data that identifies various charities, and generates distribution data indicating those beneficiaries that have been selected, and where needed a distribution amongst beneficiaries. The system is arranged to output data which represents a distribution to the different beneficiaries of the donations made by different donors according to the distribution data and for this purpose includes an Internet website enabling the cardholders to each select one or more beneficiaries or to alter their selection of beneficiaries and where needed to select or to alter the selection of the distribution of contributions amongst two or more selected beneficiaries, to constitute or to update said distribution data. In this way each cardholder can select a mix of beneficiaries.

The aforementioned system enables the users to select and amend their choice of beneficiaries, but the possibilities available to the users for doing this are limited.

### SUMMARY OF THE INVENTION

An object of this invention is to facilitate the collection and distribution of charitable donations by providing new possibilities for promoting the adoption of an individual's or an organization's personal mix of beneficiaries or personal donation profile.

The invention therefore provides a computerized system for managing the distribution of donations among a plurality of beneficiaries selectable by the donors or by authorized third parties, which system stores: beneficiary data that identifies a plurality of beneficiaries (in particular charities), and distribution data indicating those beneficiaries that have been selected, and where needed a distribution amongst beneficiaries, and is arranged to output data which represents a distribution to the different beneficiaries of the donations made by different donors according to said distribution data.

The system comprises data input means (usually materialized by an Internet website) for enabling donors or authorized third parties who access the system via the data input means to each select one or more beneficiaries or to alter their selection of beneficiaries and where needed to select or to alter the selection of the distribution of contributions amongst two or more selected beneficiaries, to constitute or to update said distribution data, whereby each donor or authorized third party can select a mix of beneficiaries. For convenience this will hereinafter be referred to as a “Personal Donation Profile” or “PDP”.

The mix of beneficiaries (PDP) can consist of a distribution of several beneficiaries with weightings that normally add up to 100%, or 100% of a single beneficiary.

According to the invention, the system is so arranged to operate that when a given donor or authorized third party accesses the data input means to establish or modify a selected mix of beneficiaries, in other words to create or modify a PDP, at least one previously-established selected mix of beneficiaries (PDP) established by another donor or authorized third party is made available to the given donor or authorized third party by the data input means or externally thereof, such that the given donor or authorized third party can establish a new or modified mix of beneficiaries (PDP) which adopts at least one of the previously-established selected mixes of beneficiaries, and such that successive donors or authorized third parties can likewise establish new or modified mixes of beneficiaries which adopt previously-established selected mixes of beneficiaries.

This system provides new possibilities for the users to adopt pre-established PDP's, enabling them to promote PDP's and encourage new charitable donations.

The system's data input means preferably comprises an Internet website accessible to donors and authorized third parties. The website can also be used to input personal data of the users, donors and authorized third parties. The means for storing beneficiary data, calculating and outputting the distribution data, is in principle a part of a computer that has appropriate software for this.

In the inventive system, donations can be made by the donors who also select the distribution data, or donors like corporate donors who donate an amount to charity to be distributed according to the choice of personnel (“authorized third parties”). Donations can be one-off, periodic or variable, like contributions collected as a function of credit card spending according to the aforementioned WO 2009/036362. All that is required is that the donation be identified with a particular donor who makes the donation or on whose behalf a donation is made.

Donations can thus be “direct” (by the donor/user) or “indirect” i.e. where the actual donor does not choose or entirely choose the weighting distribution.

The invention also provides a method of users adopting PCPs, in particular in a system as defined above, wherein a first user called “promoter” offers his PDP for adoption, and a second user called “adopter” adopts the PDP of the first user as part or all of his own PDP.

### BRIEF DESCRIPTION OF THE DRAWINGS

The invention will be further described by way of example with reference to the accompanying drawings, in which:

FIG. 1 is a diagram of one embodiment showing how PDPs can be adopted by different users in a management system according to the invention.

FIG. 2 is a diagram of a modified embodiment showing how PDPs can be adopted by different users in a management system according to the invention.

FIG. 3 is a diagram of the system layout.

### DETAILED DESCRIPTION

The invention provides a system and method for managing a computerized web-based exchange of multiple personal donation profiles (PDP) among a multiplicity of donors and authorized third parties in view of promoting the adoption of PDPs, wholly or in part, by so-called adopting donors.

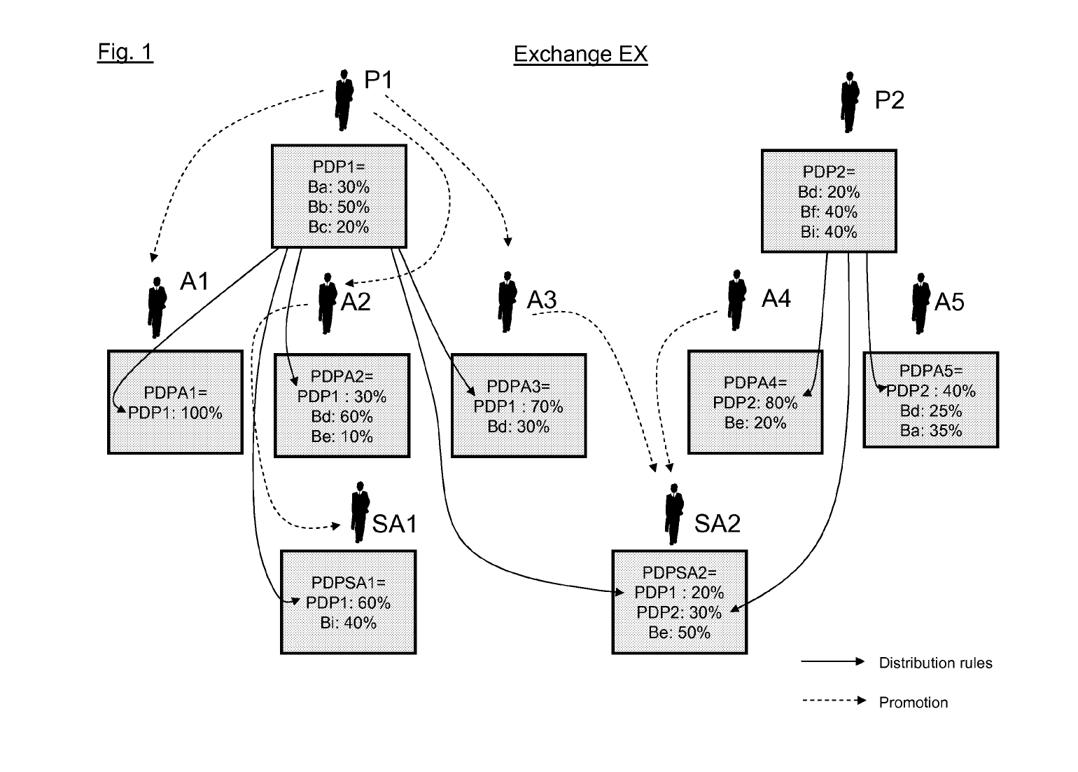

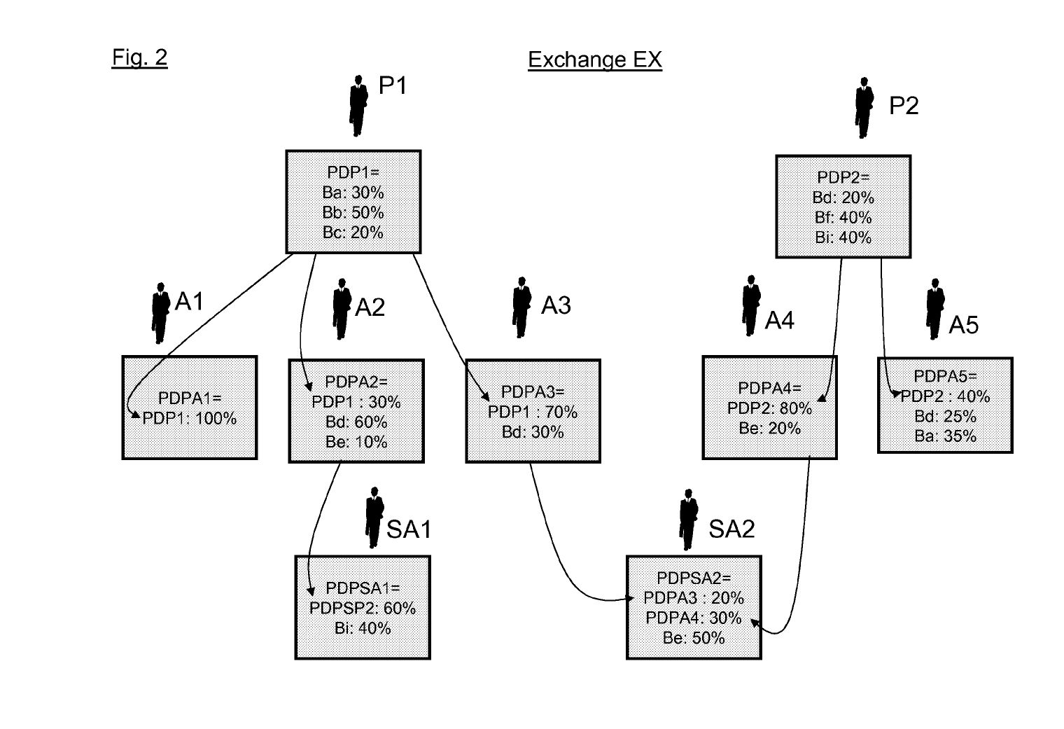

FIGS. 1 and 2 schematically illustrate the inventive way PDPs are adopted by later users.

FIG. 1 schematically shows the system and method of how two particular users called promoters P1 and P2 promote their respective PDPs, in this case PDP1 and PDP2, created by each of promoters P1 and P2. First, P1 and P2 must be members or participants of an overall system for collecting and distributing donations in particular charitable donations, called exchange EX, which exchange EX represents the inventive system and also features beneficiaries Ba, Bb, Bc, etc . . . , eligible for donations by EX members/participants. Promoters P1 and P2 select their choice of beneficiaries for their donations in their respective PDP and, where there is a selection of multiple beneficiaries, allocate a weight to each of these beneficiaries. In this example, promoter P1 has selected beneficiaries Ba, Bb and Bc in its PDP1, with respective weights of 30%, 50% and 20%. Where for example promoter P1 makes a donation of $100, $30 will go to beneficiary Ba, $50 to beneficiary Bb and $20 to beneficiary Bc. On the other hand, in this example, promoter P2 has selected beneficiaries Bd, Bf and Bi in his PDP2, with respective weights of 20%, 40% and 40% so donations by promoter P2 will be allocated according to his PDP2.

As illustrated, promoter P1 has also offered to other members of exchange EX the possibility to adopt promoter P1's PDP1 fully or partly as their own PDP (symbolized by dotted arrows). Equally, promoter P2 has offered his own PDP2 for adoption by other members of exchange EX. In this example, adopters A1, A2 and A3, who are also members/participants in exchange EX, have indeed adopted PDP1 in one form or another. Adopter Al has selected PDP1 in its entirety (100%) as his own, which means that any donation that adopter A1 will make, will be spread the exact same way as for promoter P1's donations. Adopter A2 has elected to adopt PDP1 with a weight of 30% and has made his own choice of charities for the balance, namely 60% to beneficiary Bd and 10% to beneficiary Be. Consequently, the allocation of a donation of $600 by or on behalf of adopter A2, will be: $360 to beneficiary Bd, $60 to beneficiary Be, $54 (=$600×30%×30%) to beneficiary Ba, $90 (=$600×30%×50%) to beneficiary Bb and $36 (=$600×30%×20%) to beneficiary Bc.

As shown, adopters A4 and A5 have adopted PDP2 with a different weight but according to the same system.

Sub-adopters SA1 and SA2 have been made aware, through promotion by one or more of adopters A1, A2, A3, A4 or A5 (symbolized by the dotted arrows) of the existence of promoted personal donation profiles PDP1 or PDP2 created by promoters P1 and P2. In this example, sub-adopter SA1 has adopted PDP1 with a weight of 60% in its own PDPSA1 and beneficiary Bi for the balance of 40%. Sub-adopter SA2, however, has adopted both BDP1 and PDP2 with different weights (20% and 30% respectively) in his own PDPSA2, and has selected directly beneficiary Be for the balance of 50%. It follows that a donation of $500 by or on behalf of sub-adopter SA2 would be allocated as follows: $250 to beneficiary Be, $30 (=$500×20%×30%) to beneficiary Ba, $50 (=$500×20%×50%) to beneficiary Bb, $20 (=$500×20%×20%) to beneficiary Bc, $30 (=$500×30%×20%) to beneficiary Bd, $60 (=$500×30%×40%) to beneficiary Bf and $60 (=$500×30%×40%) to beneficiary Bi.

FIG. 2 schematically shows a variation of the invention, with a pyramid structure for PDPs, where adopters of the PDP of a promoter, may promote their own PDP (comprising partly or entirely the PDP of the higher level promoter) to a lower level of adopters. As in the system described in FIG. 1, adopters A1, A2 and A3 have adopted PDP1 created by promoter P1, while adopters A4 and A5 have adopted PDP2 created by promoter P2. In turn, adopter A2 promoted his own PDPA2, made up of PDP1 of promoter 1 with a weight of 30% and added as personal choice beneficiary Bd for 60% and beneficiary Be for 10%. In turn, sub-adopter SA1 elected to adopt PDPA2 of adopter A2 for a weight of 60%, and his own choice of beneficiary Bi for 40%. In Group Y, adopter A4 promoted his own PDPA4. Now, in this example, sub-adopter SA2 adopted two different PDPs from two different promoters: indeed, sub-adopter SA2 created his own PDPSA2 and adopted PDPA3 of adopter A3 with a weight of 20%, and PDPA4 of adopter A4 with a weight of 30%, adding his own choice of beneficiary Be for the balance with a weight of 50%. It follows that a donation of $1000 by or on behalf of sub-adopter SA2 yields a donation of $500 to beneficiary Be, $42 (=$1000×20%×70%×30%) to beneficiary Ba, $70 (=$1000×20%×70%×50%) to beneficiary Bb, $28 (=$1000×20%×70%×20%) to beneficiary Bc, $60 (=$1000×20%×30%) to beneficiary Bd (via PDPA3), $48 (=$1000×30%×80%×20%) again to beneficiary Bd (via PDPA4), $96 (=$1000×30%×80%×40%) to beneficiary Bf, $96 (=$1000×30%×80%×40%) to beneficiary Bi, and a further $60 (=$1000×30%×20%) to beneficiary Be via PDPA4.

Any change in the PDP of a promoter P1, P2 and/or, in the variation of FIG. 2, in the PDP of a sub-promoter A2, A3, A5, can change the PDPs of the adopters and sub-adopters, respectively. In such case, in the event that there is a change in the PDP of a promoter, the exchange EX can optionally be arranged to notify any concerned adopter.

Any adopter and sub-adopter may change the composition of its PDP by adding or removing beneficiaries and upper-level PDPs and by shifting weights for beneficiaries or upper level PDP. For example, if in FIG. 2, promoter P1 changes his distribution mix to weights of 70% to Ba, 10% to Bb and 20% to Bc, and adopter A4 changes his distribution mix to 30% to PDP2 and 70% to Bb (removing Be altogether from his mix), a donation of $1000 by or on behalf of sub-adopter SA2 now yields the following donations: the donation of $500 to beneficiary Be remains unchanged; $98 (=$1000×20%×70%×70%) to beneficiary Ba; $14 (=$1000×20%×70%×10%) to beneficiary Bb; $28 (=$1000×20%×70%×20%), unchanged, to beneficiary Bc; $60 (=$1000×20%×30%), unchanged, to beneficiary Bd (via PDPA3); $18 (=$1000×30%×30%×20%) again to beneficiary Bd (via PDPA4); $36 (=$1000×30%×30%×40%) to beneficiary Bf; $36 (=$1000×30%×30%×40%) to beneficiary Bi; and a further $210 (=$1000×30%×70%) to beneficiary Bb via PDPA4. A variation would consist in allowing adopters, being informed by exchange EX of any changes in the PDP of a promoter, to “opt out” from that particular change. Conversely, the system may also be arranged to not automatically update an adopter's PDP with any changes in a promoter's PDP, but instead to inform such adopters and allow them to “opt in” that particular change. Both “opt-in” and “opt-out” variations may apply on a case-by case basis, or be engineered to last (for any future change occurrence) until disabled, in other words, to freeze a PDP in its distribution choices and weights until unfrozen, or to continuously adjust a PDP with any changes in a promoter's PDP until frozen again

Another variation of the systems and methods described in FIGS. 1 and 2 consists in allowing adopters to select various PDPs of various promoters with a view to use them sequentially, for instance a rotational PDP or alternatively as a contingent PDP. A rotational PDP is a system where a donor allocates one of several adopted PDPs to a particular periodic donation; for example, a donor's January donation will be allocated according to one PDP of a first promoter, the February donation will be allocated to another PDP of a second promoter etc . . . PDPs adopted from various promoters may apply alternatively on a contingency such as in relation to a particular type of donation: for instance one PDP of a first promoter is adopted for distribution of one-off donations, while a second PDP of a second promoter is adopted for distribution of fixed recurring donations, while a third PDP of a third promoter is adopted for distribution of recurring donations based on that donor's expenditures, as described in WO 2009/036362.

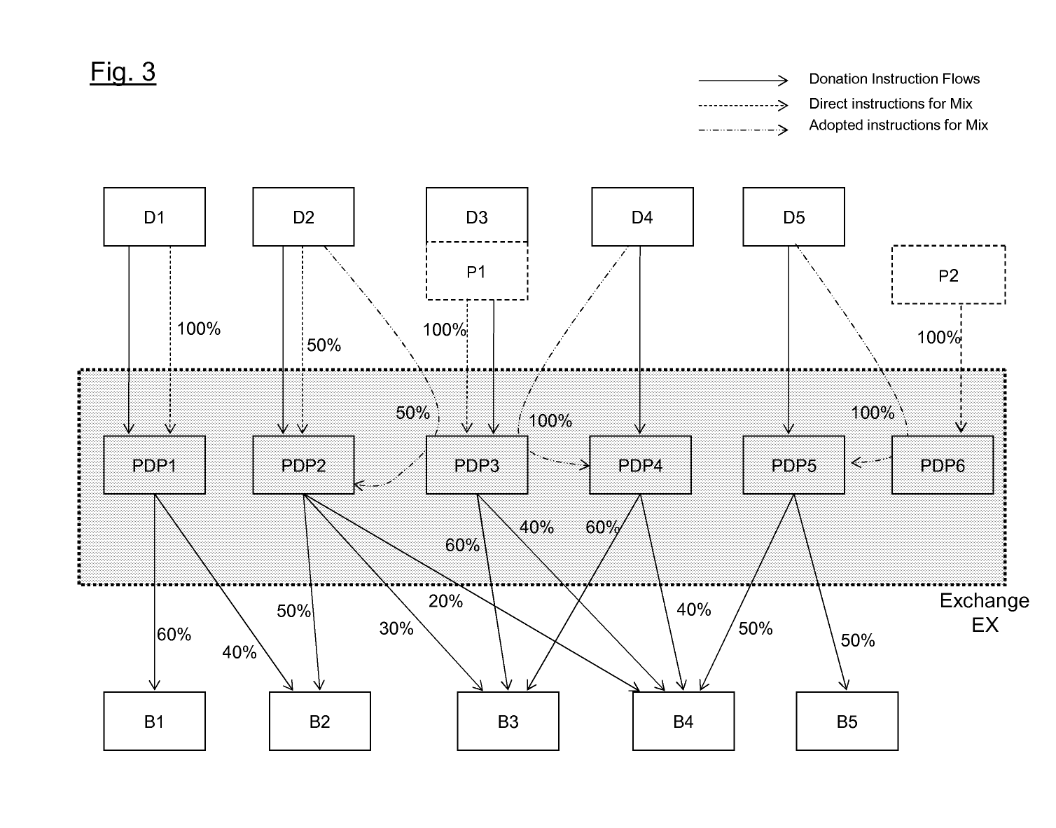

FIG. 3 illustrates the layout of a system for managing the distribution of donations as explained with reference to FIGS. 1 and 2. As shown, a plurality of donors for example donors D1, D2, D3, D4, D5 each have created their PDPs on exchange EX which constitutes the system's data input means and can be implemented by a website accessible to the users and authorized parties. In exchange EX, each respective PDP input by the donor and stored in the exchange EX defines the distribution rules for their cash donations to a different plurality of beneficiaries, for example B1, B2, B3, B4, B5. The straight arrows represent the donation instruction flows, which in every case are operated via exchange EX. Donor D1 has defined 100% of his PDP1 on his own (symbolized by the dotted arrow), with his donations going to beneficiaries B1 (60%) and B2 (40%) of his own choice. Donor 2 has defined his PDP2 to represent 50% distribution (dotted arrow) to his own choice of beneficiary B2, and 50% distribution according to the PDP3 created by promoter P1 (symbolized by the checkered arrow). Promoter P1 has selected beneficiaries B3 (60%) and B4 (40%) in his PDP3. As a consequence, according to donor D2's PDP2 (adopting PDP3 with a weight of 50%), 30% of his donations will go to beneficiary B3 and 20% to beneficiary B4. Promoter 1 also happens to be donor D3, so his donations will follow 100% of his own PDP3. Donor D4 has opted for 100% of his PDP4 to reflect PDP3 of promoter P1 (so, no dotted arrow), so his donations will be spread among beneficiaries B3 and B4 exclusively along the rules defined in PDP3 by donor D3. Donor D5 has adopted 100% of PDP6 of promoter P2 to serve as his own PDP5 (so, no dotted arrow), with donor D5's donations going to beneficiaries B4 (50%) and B5 (50%).

In all cases, actual payments do not need to transit through the exchange EX but may pass via a banking system. In all examples, the funds flow/management of money in practice is handled by the system from where the onward distribution takes place. All donations will be identified according to the identification (PDP) of the donor or authorized third party.

The described system may also provide for variations, where promoters are not necessarily donors. An example would be for opinion leaders to publish PDPs that are likely to raise adoption of their PDP in the general public or to selected recipients; such PDPs may be sectorial PDPs promoting specific beneficiaries for their activities in a particular charitable sector. Another example would be for rating institutions or advisory groups that can offer customized PDPs for general adoption. As represented in FIG. 3, promoter P2 has defined in his PDP6 distribution rules to beneficiaries B4 (50%) and B5 (50%), but promoter P2 is not himself a donor. His opinion and choice of beneficiaries is obviously important to donor D5, who adopted 100% of promoter P2's PDP6 for his own donations according to PDP5.

Another variation would consist of employees promoting their PDP for inclusion in corporate donation schemes of their employer so that corporate donations are determined wholly or partly by the composition of employees' PDP's, or for members of an association, club or community to cast their votes through their PDP preference for the distribution of donations of such associations, clubs or communities. Equally, operators of affinity programs to their loyal customers, such as retail chains or airlines, could allow loyalty points to be converted into votes to influence the choice of beneficiaries and the distribution weight for corporate donations by such operators. Referring to FIG. 3, promoter P2 may be an employee a club-member or a consumer. According to this variation, donor D5 may be the employer of promoter P2, or his club or an affinity program operator.

An example of sharing PDPs would be where a promoter creates and shares a PDP in support of local or interest-specific beneficiaries/charities.

Yet another variation would consist of a donor issuing a gift voucher to a third party. That voucher is for a specific amount of money, which the recipient may redirect to beneficiaries selected within his own PDP, or in lieu of or in addition, to beneficiaries selected within the PDP of the issuer of the voucher, this offered for adoption by the recipient. Referring to FIG. 3, donor D5 is the issuer of the voucher, and promoter P2 the recipient of the voucher, according to the PDP6 of whom, donor D5 makes the donations to beneficiaries B4 (50%) and B5 (50%).

In a further variation, a donor or authorized party may create several PDPs which may or may not be associated with a different payment method (credit card, bank transfer, standing order, direct debit, etc.).

In another example relating to the filing of end-of-year income tax returns, in those territories where an individual is able to designate on the income tax return forms a charity-related donation or for example a charity-related refund/rebate, that individual may delegate any such donation/refund/rebate to their PDP of the inventive system and therefore to the beneficiaries of their PDP at the weightings in force when the donation/refund/rebate is credited to the system.

In yet another example of how the inventive system can be utilized, employees using payroll giving schemes to donate money to charities directly from the salary paid via the company's payroll can instruct such donations to be directed (via the Exchange or not) for distribution according to their PDP.

1. A computerized system for managing the distribution of donations among a plurality of beneficiaries selectable by the donors or by authorized third parties, which system stores:
beneficiary data that identifies a plurality of beneficiaries, and
distribution data indicating those beneficiaries that have been selected, and where needed a distribution amongst beneficiaries,
and is arranged to output data which represents a distribution to the different beneficiaries of the donations made by different donors according to said distribution data;
and wherein the system comprises data input means for enabling donors or authorized third parties who access the system via the data input means to each select one or more beneficiaries or to alter their selection of beneficiaries and where needed to select or to alter the selection of the distribution of contributions amongst two or more selected beneficiaries, to constitute or to update said distribution data, whereby each donor or authorized third party can select a mix of beneficiaries,
characterised in that
the system is so arranged to operate that when a given donor or authorized third party accesses the data input means to establish or modify at least one selected mix of beneficiaries, at least one previously-established selected mix of beneficiaries established by another donor or authorized third party is made available to the given donor or authorized third party by the data input means or externally thereof, such that the given donor or authorized third party can establish a new or modified mix of beneficiaries which adopts at least part of one of the previously-established selected mixes of beneficiaries, and such that successive donors or authorized third parties can likewise establish new or modified mixes of beneficiaries which adopt previously-established selected mixes of beneficiaries.

2. The system according to claim 1, wherein the data input means comprises an Internet website accessible to donors and authorized third parties.

3. The system according to claim 1, which is so arranged that any change in the mix of beneficiaries, hereinafter designated “PDP” of a user that has been adopted by other users, hereinafter called “adopters”, is automatically applied to the mix of beneficiaries (“PDP”) of the adopters.

4. The system of claim 1, which is so arranged that any user, hereinafter called “adopter” or “sub-adopter”, that has adopted the mix of beneficiaries (PDP) of another user designated “upper level PDP”, may change the composition of its PDP by adding or removing beneficiaries and upper level PDPs and by adjusting the weighting for beneficiaries or upper level PDPs.

5. A method of users adopting mixes of beneficiaries, hereinafter called “PDPs”, in a system according claim 1, wherein a first user called “promoter” offers his PDP for adoption, and a second user called “adopter” adopts the PDP of the first user as part or all of his own PDP.

6. The method according to claim 5, wherein any change in the mix of beneficiaries (“PDP”) of a user that has been adopted by other users (“adopters”) is automatically applied to the mix of beneficiaries (“PDP”) of the adopters.

7. The method according to claim 5 wherein any user, hereinafter called “adopter” or “sub-adopter”, that has adopted the mix of beneficiaries (PDP) of another user designated “upper level PDP” may change the composition of its PDP by adding or removing beneficiaries and upper level PDPs and by adjusting the weighting for beneficiaries or upper level PDPs.
